(19) United States
(12) Patent Application Publication
(10) Pub. No.: US 2009/0205894 A1
(43) Pub. Date: Aug. 20, 2009

(54) Leaning vehicle

(76) Inventor: Harry E. Eaton, Windsor Heights, IA (US)

Correspondence Address: BRETT J. TROUT, PC, 516 WALNUT, DES MOINES, IA, 50309, US

(21) Appl. No.: 12/070,458

(22) Filed: Feb. 19, 2008

(51) Int. Cl. B62D 61/08

(52) U.S. Cl. 180/210

(57) ABSTRACT

A three wheeled motorcycle is provided with a rear wheel support which pivots as the motorcycle turns. In addition to pivoting, the wheel support allows the frame to lean into the turn, thereby increasing the speed and safety with which a rider may take a turn with the motorcycle. The rotation of the wheel support and angle of lean may be determined manually by a rider or may be automatically programmed to react to changing forces and road conditions as the motorcycle moves through a turn.

### BACKGROUND OF THE INVENTION

1. Field of the Invention

The present invention relates in general to a three wheeled motorcycle and, more particularly, to a three wheeled motorcycle which allows the motorcycle to lean relative to the rear wheel assembly during turning, and which allows the rear wheel assembly to turn relative to the motorcycle frame.

2. Description of the Prior Art

Three wheeled motorcycles, also known as “three wheelers” or “trikes,” are well known in the art. Three wheeled motorcycles are often selected over standard two wheeled motorcycles due to the stability associated with the three wheeled motorcycles at low speeds and at rest. Although three wheeled motorcycles provide added stability at low speeds and at rest, front wheel traction is often compromised during turning.

Turning a three wheeled motorcycle often requires the rider to corner more slowly than the rider otherwise would with a standard two wheeled motorcycle. Unlike a two wheeled motorcycle which leans into the turn, a three wheeled motorcycle remains upright through the turn, requiring the front wheel to be turned at a much greater angle relative to the frame of the motorcycle. Conversely, two wheeled motorcycles are often navigated through a turn by what is referred to as “counter steer.” This involves pushing forward on the left handlebar when turning left, and pushing forward on the right handlebar when turning right. Three wheeled motorcycles do not counter steer. Instead, when turning a three wheeled motorcycle left, the right handlebar is pushed forward and vice versa. The front wheel also must be turned radically relative to the frame of the motorcycle to achieve the same degree of turning radius.

When turning a three wheeled motorcycle, inertia tends to pull the rider laterally from the seat. In a standard two wheeled motorcycle turn, the bike is leaning into the turn, causing the inertia of the rider to push the rider more deeply into the seat, rather than laterally off of the seat. It would, therefore, be desirable to combine all of the advantages associated with a two wheeled motorcycle's ability to lean into a turn with all of the slow speed and rest stability associated with a three wheeled motorcycle.

The difficulties encountered in the prior art discussed hereinabove are substantially eliminated by the present invention.

### SUMMARY OF THE INVENTION

In an advantage provided by this invention, a three wheeled motorcycle is provided with a frame which leans as the motorcycle turns.

Advantageously, this invention provides a three wheeled motorcycle with a rear wheel assembly which turns relative to the motorcycle frame.

Advantageously, this invention provides a three wheeled motorcycle with increased safety features.

Advantageously, this invention provides a three wheeled motorcycle which allows for taking corners at increased speed.

Advantageously, this invention provides a system for converting a two wheeled motorcycle to an improved three wheeled motorcycle.

In an embodiment of this invention, a vehicle is provided with a wheel support having a first and second wheel attached thereto. The wheel support is pivotally coupled to a support mount of the vehicle along an axis which is non-parallel and non-perpendicular to the vehicle's direction of travel. In the preferred embodiment, the vehicle is a three wheeled motorcycle and the support mount is a cylindrical mount cut at an angle to form an elliptical face. The wheel support is coupled to the support mount using a pin located normal to the elliptical face of the support mount. Bearings or other low friction material are provided between the wheel support and the support mount to allow the wheel support and support mount to rotate relative to one another as the three wheeled motorcycle turns. As the three wheeled motorcycle turns, the wheel Support turns relative to the frame of the three wheeled motorcycle and the frame of the three wheeled motorcycle leans into the direction of the turn.

### BRIEF DESCRIPTION OF THE DRAWINGS

The present invention will now be described, by way of example, with reference to the accompanying drawings in which:

FIG. 1 illustrates a perspective view of the three wheeled motorcycle of the present invention;

FIG. 2 illustrates a top elevation of the rear wheel assembly of the present invention;

FIG. 3 illustrates an exploded side elevation in partial phantom of the wheel support and support mount;

FIG. 4 illustrates a top elevation of the three wheeled motorcycle of the present invention making a right turn; and

FIG. 5 illustrates the three wheeled motorcycle of the present invention making a left turn.

### DETAILED DESCRIPTION OF THE PREFERRED EMBODIMENT

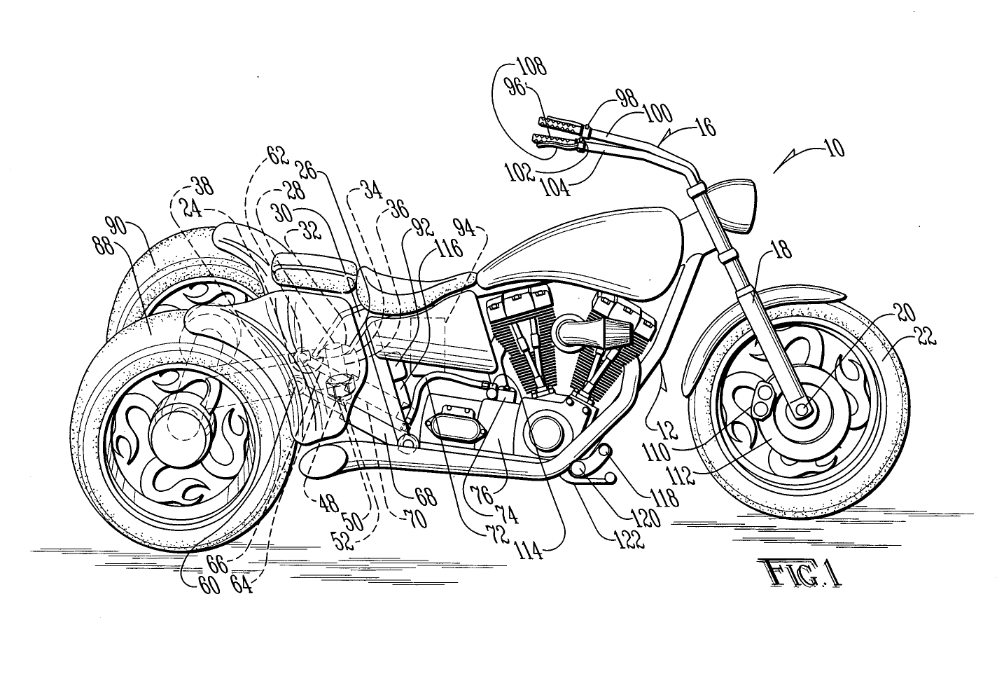

With reference to the drawings, a three wheeled motorcycle according to the present invention is shown generally as (10) in FIG. 1. The three wheeled motorcycle (10) includes a frame (12) housing a standard gasoline engine (14). Handlebars (16) are pivotally coupled to the frame (12) in a manner such as that known in the art. Pivotally coupled to the handlebars (16) are a pair of shock absorbers (18) which, in turn, are secured to the axle (20) of a front wheel (22). The frame (12), engine (14), handlebars (16), shock absorbers (18), axle (20) and front wheel (22) may all be of a type such as that known in the art. Although in the preferred embodiment these items are custom designed for the motorcycle (10), they may be taken directly from a standard two wheeled motorcycle for which a conversion to the present invention is desired.

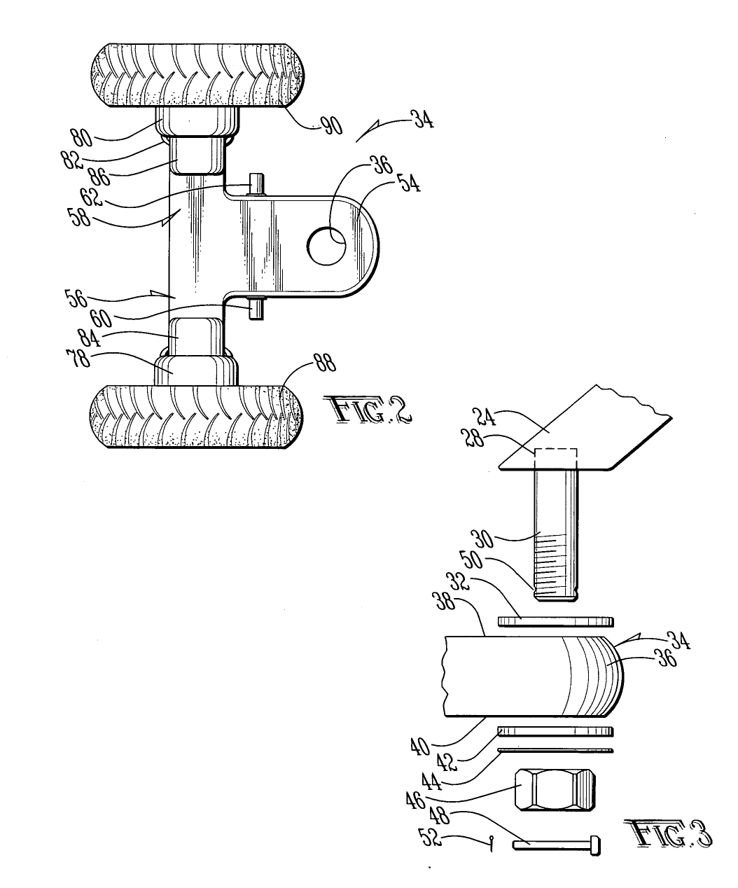

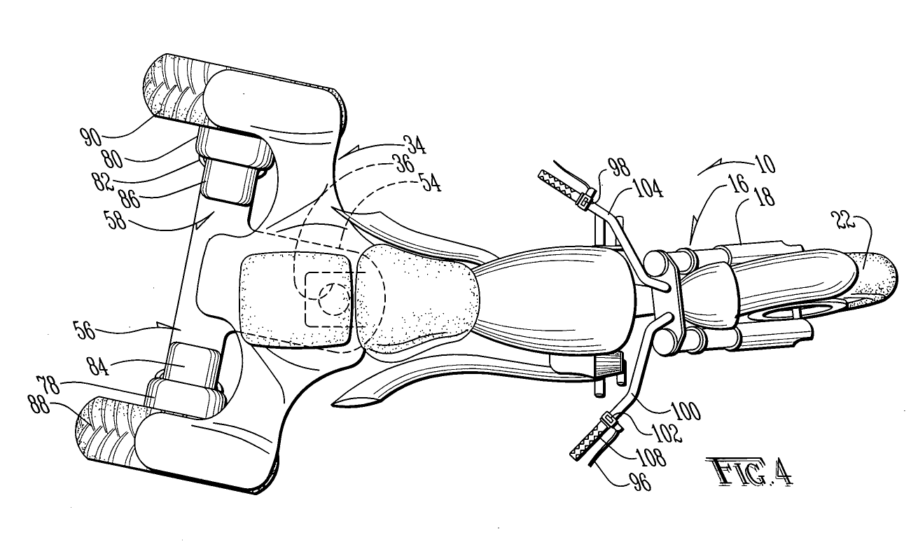

As shown in FIG. 1, coupled to the rear of the frame (12) is a support mount (24). The support mount (24) is preferably a solid cylinder of aluminum cut on an angle to define an elliptical face (26). Provided into the support mount (24), normal to the elliptical face (26), is a cylindrical slot (28). Welded into the cylindrical slot (28) is a steel journal leg (30). Provided over the steel journal leg (30) is a thrust bearing (32), which may be of ball bearing, roller, fluid film or any other known type of bearing. Provided over the thrust bearing is a wheel mount (34), provided with a cylindrical throughslot (36) of a diameter slightly greater than the diameter of the journal leg (30). (FIGS. 1 and 2). The wheel mount (34) is provided with an interior face (38) in contact with the thrust bearing (32) and an exterior face (40). (FIGS. 1 and 3). Provided over the journal leg (30), and in contact with the exterior face (40), is another thrust bearing (42) which may be of similar construction to the thrust bearing (32).

Provided over the thrust bearing (42) is a steel washer (44) and a threaded nut (46). The threaded nut (46) is held in place by a clevis pin (48) passing through a hole (50) in the journal leg (30). The clevis pin (48), in turn, is held in place by a cotter pin (52) secured through the clevis pin (48).

As shown in FIG. 2, the wheel mount (34) is constructed of a head (54), a first shoulder (56) and a second shoulder (58). The wheel mount (34) may be constructed of any suitable material, but in the preferred embodiment the wheel mount (34) is constructed of steel. Provided on each shoulder (56) and (58) is a knob (60) and (62) which, as shown in FIGS. 1-2, are each coupled to a shaft (64) and (66). The shafts (64) and (66) are each coupled to a hydraulic cylinder (68) and (70).

The hydraulic cylinders (68) and (70) are pivotally secured to the frame (12) of the motorcycle (10) and coupled by hydraulic lines (72) to a hydraulic pump (74). The hydraulic pump (74) is preferably driven by a belt coupled to the engine (14). While the hydraulic pump (74) may be of any type known in the art, in the preferred embodiment, the hydraulic pump (74) generates at least 3500 pounds per square inch of hydraulic pressure and is coupled to the engine (14) in a manner in which each turn of the crank shaft (not shown) of the engine (14) rotates the hydraulic pump (74) one-half turn.

The hydraulic pump (74) is coupled to a sump (76) to which hydraulic fluid (not shown) is returned and from which hydraulic fluid is sumped back into the hydraulic pump (74). The hydraulic pump (74) is also coupled to a pair of hydraulic motors (78) and (80) by hydraulic lines (82). As shown in FIG. 2, the hydraulic motors (78) and (80) are secured to arms (84) and (86) of the wheel mount (34) extending from the shoulders (56) and (58). The hydraulic motors (78) and (80) may be of any suitable type known in the art, including of a vane, gear, swath or piston design. The hydraulic motors (78) and (80) are each coupled to a wheel (88) and (90).

As shown in FIG. 1, the hydraulic pump (74) is coupled to a central processing unit (92). The central processing unit (92) is coupled to the battery (94) of the motorcycle (10). Also coupled to the central processing unit (92) is the rotatable throttle (96) and switch (98) on the right handlebar (100). The central processing unit (92) is also coupled to a switch (102) on the left handlebar (104).

The switch (102) on the left handlebar (104) is coupled to a variable valve (106) in fluid communication with the hydraulic pump (74). The variable valve (106) changes the direction of hydraulic fluid flow to the hydraulic motors (78) and (80), thereby changing the direction of the motorcycle (10) from forward to reverse and back. The throttle (96) is coupled to the hydraulic pump (74) to supply fluid to the hydraulic motors (78) and (80), thereby controlling the speed of the motorcycle (10). A standard brake lever (108) is coupled to calipers (110) provided over the front brake disc (112) in a manner such as that known in the art.

The switch (98) provided on the right handlebar (I 00) is preferably of a toggle type and spring loaded to return to center. When moved in an upward direction, the switch (98) signals the central processing unit (92) to actuate valves (114) which deliver hydraulic fluid from the hydraulic pump (74) to the hydraulic cylinders (68) and (70), to provide hydraulic fluid to one cylinder (68) while allowing fluid from the other cylinder (70) to drain back to the sump. Conversely, when the switch (98) is moved downward, the switch (98) signals the central processing unit (92) to cause the valves (114) to supply hydraulic fluid to the hydraulic cylinder (70) and allow hydraulic fluid from the hydraulic cylinder (68) to return to the sump (76).

Alternatively or additionally, the central processing unit (92) may be coupled to a motion sensor (116) which senses momentum change and centrifugal force to automatically trigger actuation of the valves (114) to turn the wheel mount (34) in the appropriate direction. Alternatively, the central processing unit (92) can be coupled to the foot pegs (118) and (120) to cause the valves (114) and hydraulic cylinders (68) and (70) to turn the wheel mount (34) in response to an rider initiated pressure differential between the foot pegs (118) and (120).

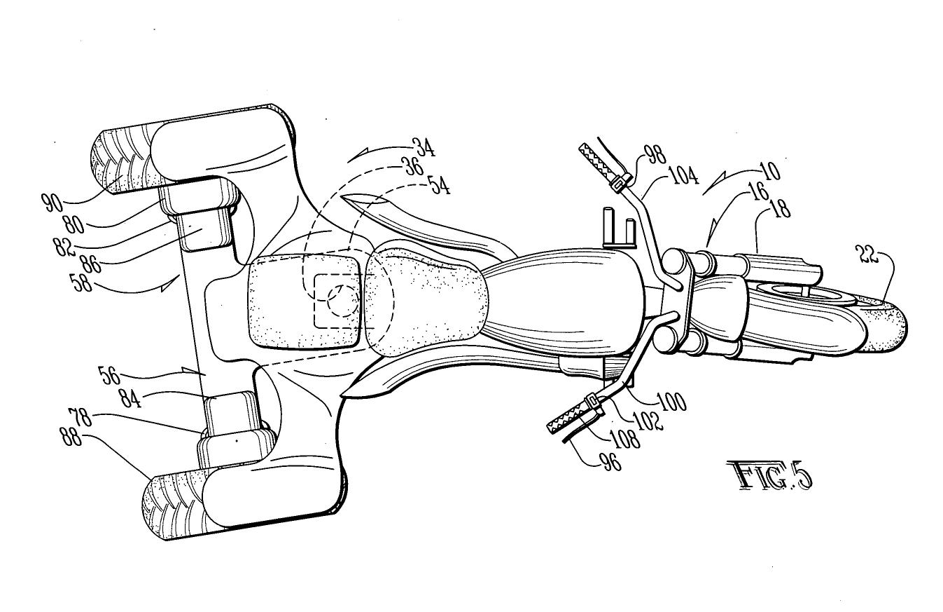

As shown in FIG. 4, when it is desired to turn right, the rider (not shown) pushes forward on the left handlebar (104) and pulls back on the right handlebar (100). The rider then moves the switch downward, thereby causing the hydraulic cylinders (68) and (70) to pivot the wheel mount (34) counter clockwise relative to the frame. Due to the angle of the elliptical face (26) of the support mount (24), as the wheel mount (34) rotates counter clockwise, the frame (12) of the motorcycle leans to the right, as shown in FIG. 4. This lean to the right translates downward forces on the rider into the frame (12), allowing the rider to take the corner more safety at a higher rate of speed without the need for turning the handlebars (16) as much as would otherwise be required. Due to the rotation of the wheel mounts (34) in combination with the lean of the frame (12), even at higher speeds the likelihood of rolling as the motorcycle (10) turns and “high siding” the rider are reduced.

Similarly, when it is desired to turn to the left, the rider pushes the right handlebar (100) outward and pulls the left handlebar inward, while pushing the switch (98) upward. As shown in FIG. 5, this action rotates the wheel mount (34) clockwise, thereby causing the frame (12) to lean to the left. The leftward leaning of the frame (12) reduces the angle at which the handlebars (16) must be turned, again increasing the speed and safety with which the rider takes the corner.

When it is desired to make the motorcycle (10) go faster or slower, the rider merely twists the throttle (96) in a manner similar to that used in association with prior art motorcycles. The twisting of the throttle (96) provides more or less hydraulic fluid pressure to the hydraulic motors (78) and (80). If it is desired to stop, in addition to twisting the throttle (96), the rider may employ the brake lever (108) and/or the foot brake (122) to slow the motorcycle (10). While the brake lever (108) slows the motorcycle (10) in a matter such as that known in the art, the foot brake (122) is preferably coupled to the variable valve (106), which either slows or reverses the flow of hydraulic fluid to the hydraulic motors (78) and (80). When it is desired to reverse the direction of the motorcycle, the rider presses the switch (102) on the left handlebar (104) to cause the variable valve (106) to reverse the flow of hydraulic fluid to the hydraulic motors (78) and (80).

In an alternative embodiment of the present invention, the central processing unit (92) can be programmed to place the hydraulic cylinders (68) and (70) into a “float” mode, whereby hydraulic fluid flows freely to and from the cylinders (68) and (70) and the sump (76). This allows the wheel mount (34) to turn as the rider leans into turns, while preventing undesired jarring or violent movement of the wheel mount (34), which could cause undesired erratic movement of the wheel mount (34). In this mode, the hydraulic cylinders (68) and (70) in effect act as shock absorbers to attenuate the speed of rotation of the wheel mount (34). The degree of float, namely the ease with which hydraulic fluid is allowed to float back and forth between the cylinders (68) and (70) and sump (76), may be adjusted for various road conditions.

Although the invention has been described with respect to a preferred embodiment thereof, it is to be understood that it is not to be so limited, since changes and modifications can be made therein which are within the full, intended scope of this invention as defined by the appended claims. For example, it is anticipated that the wheel mount (34) and frame (12) of the present invention may be utilized in association with non-powered or human powered vehicles. It is also anticipated that the present invention may be utilized in association with vehicles having more than three wheels. It is also anticipated that the present invention may be utilized in association with vehicles powered by solar, wind, fossil fuels, which transfer energy by belts, shafts, gears, chains or any other production or transport known in the art.

What is claimed is:

1. A vehicle comprising:
(a) a wheel support;
(b) a first wheel coupled to said wheel support;
(c) a second wheel coupled to said wheel support;
(d) a support mount;
(e) means for pivotably coupling said wheel support to said support mount along an axis; and
(f) wherein said axis is non-parallel and non-perpendicular relative to a direction of travel of the vehicle.

2. The vehicle of claim 1, wherein at least a first portion of said wheel support is located above at least a first portion of said support mount, and wherein at least a second portion of said wheel support is located below at least a second portion of said support mount.

3. The vehicle of claim 1, further comprising a third wheel coupled to the vehicle, wherein said axis extends from a first point above said first wheel on an opposite side of said first wheel from said third wheel to a second point below said first wheel on the same side of said first wheel as said third wheel.

4. The vehicle of claim 1, wherein said support mount is provided with an elliptical face.

5. The vehicle of claim 1, wherein said axis is tilted at least between ten and eighty degrees from a line normal to the ground when the vehicle is traveling in a straight line.

6. The vehicle of claim 1, wherein said axis is tilted at least between twenty and seventy degrees from a line normal to the ground when the vehicle is traveling in a straight line.

7. The vehicle of claim 1, wherein said axis is tilted at least between thirty-five and fifty-five degrees from a line normal to the ground when the vehicle is traveling in a straight line.

8. The vehicle of claim 1, further comprising means for driving said first wheel.

9. The vehicle of claim 1, further comprising means for moving said wheel support relative to said support mount.

10. The vehicle of claim 1, further comprising a third wheel located substantially equidistant from said first wheel and said second wheel.

11. The vehicle of claim 10, further comprising a handlebar coupled to said third wheel.

12. A vehicle comprising:
(a) a vehicle frame;
(b) a wheel assembly comprising:
(i) a wheel mount;
(ii) a first wheel coupled to said wheel mount; and
(iii) a second wheel coupled to said wheel mount;
(c) a third wheel coupled to said vehicle frame; and
(d) wherein said wheel is pivotably coupled to said vehicle frame along an axis, wherein said axis extends from a first point below and between said wheel assembly and said third wheel to a second point above said wheel assembly, wherein said wheel assembly is located between said second point and said third wheel.

13. The vehicle of claim 12, further comprising an elliptical mount coupled to said vehicle frame and wherein said wheel assembly is pivotably coupled to said elliptical mount.

14. The vehicle of claim 12, further comprising means for driving said first wheel.

15. The vehicle of claim 12, further comprising means for moving said wheel assembly relative to said vehicle frame.

16. The vehicle of claim 12, wherein said third wheel is located substantially equidistant from said first wheel and said second wheel.

17. The vehicle of claim 12, further comprising a handlebar coupled to said third wheel.

18. A vehicle comprising:
(a) a frame;
(b) a wheel assembly comprising:
(i) a wheel mount;
(ii) a first wheel coupled to said wheel mount; and
(iii) a second wheel coupled to said wheel mount;
(c) a third wheel coupled to said frame substantially equidistant from said first wheel and said second wheel; and
(d) means for leaning said vehicle frame into a turn in response to a turning of said wheel assembly relative to said vehicle frame.

19. The vehicle of claim 18, wherein said first wheel and said second wheel remain substantially spacially fixed relative to one another in response to a turning of said wheel assembly relative to said vehicle frame.

20. The vehicle of claim 18, further comprising a handlebar coupled to said third wheel.
